(19) United States
(12) Patent Application Publication
(10) Pub. No.: US 2015/0063399 A1
(43) Pub. Date: Mar. 5, 2015

(54) VESSEL LID FOR A THERMAL PLANT

(71) Applicant: Uwe Geib, Penzberg (DE)

(72) Inventor: Uwe Geib, Penzberg (DE)

(21) Appl. No.: 14/389,749

(22) PCT Filed: Mar. 28, 2013
(86) PCT No.: PCT/EP2013/056797

§ 371 Date: Sep. 30, 2014

(30) Foreign Application Priority Data
Mar. 30, 2012 (DE) 10 2012 006 584.1

(51) Int. Cl. C03B 5/42; F27D 1/18

(52) U.S. Cl. CPC C03B 5/42; F27D 1/18
USPC 373/30; 432/250

(57) ABSTRACT

The invention relates to a vessel lid in particular for a thermal plant, for example a smelting furnace or a waste incineration plant. In particular, the invention relates to a vessel lid for a thermal plant which is arranged within vessel wall elements of a vessel wall of the thermal plant and which is either vertically adjustable and/or tiltable as a whole or which consists of a plurality of lid parts of which at least one is vertically adjustable and/or tiltable. The vertical adjustment and/or the tilting of the lid or of the lid parts and also the lateral movement thereof make it possible to achieve improved thermal sealing of the lid with respect to the vessel. The invention provides that the vessel lid or one or more lid parts/lid elements can be removed and/or exchanged. Instead of the complete exchange of the lid or of a lid part/lid element, it is also possible for only a wear layer or a screen thereof to be replaced.

The invention relates to a vessel lid (also called vessel cover) in particular for a thermal plant, for example a melting furnace or a waste incineration plant. In particular, the invention relates to a vessel lid for a thermal plant which is arranged within vessel wall elements of a vessel wall of the thermal plant and which is either vertically adjustable and/or tiltable as a whole or which consists of a plurality of lid parts of which at least one is vertically adjustable and/or tiltable.

Existing plants in the field of melting technology, for example in glass melting, includes furnace systems or conveyor paths for the melt, which are constructed from selected fire-resistant construction materials. In the simplest case they are substantially composed of a base plate, the vessel (side)walls, which are substantially constructed from vessel wall elements, and the vault or lid. These elements together substantially surround the furnace interior/melting room and thus the melt. Lids with a conventional vessel wall and a rotationally symmetrical or polygonal floor area, which are rotatably placed on a lower part of the melting furnace, are known for melting furnaces.

With the term vessel wall elements, which are normally bricks, the components of a melting furnace are referred to which indirectly or directly encompass the melt or the melting material, preferably the fire-resistant components (such as wool or bricks) or melting raw materials. This means for example for a melting furnace, the components that directly encompass the melt or the upper furnace, or in case of a plurality of layers situated behind each other, also those components.

For thermal plants, for example in case of application as a glass melting furnace, the plant, e.g. the complete glass melting furnace, is subject to wear (corrosion/erosion) and has a limited lifetime, the so-called furnace campaign. A repair of worn components or vessel wall elements without a shut down or cooling down is only possible to a limited extent and negligibly increases the furnace campaign of the melting furnace. After a few years the entire melting furnace needs to be fully and cost intensively renewed. To extend the furnace campaign, vessel walls that can be pushed through are proposed; see European patent application EP 09752097.

Furthermore, melting furnaces are proposed, which vessel walls are composed of individual, replaceable veneered components; see European patent application EP 2011001574. Such melting furnaces are also rotated along an axis, allowing the use of components before they enter into contact with the melt, and the removal of worn components after they have emerged again from the melt.

Existing lid installations cannot be combined or are difficult to combine with said melting furnaces. In particular, it is difficult to achieve a sufficient sealing between the vessel lid and the vessel wall. Such a sealing is desirable to inter alia minimize thermal losses. In addition, a sealing can prevent or at least reduce the emission of exhaust gases. Finally, a sealing is required, if a particular gas atmosphere should be present in the melting room. It is also desirable to be able to replace the lid or lid parts, preferably during operation of the melting furnace, to allow for an infinite melting campaign.

It is therefore an object of the invention to provide an improved vessel lid, in particular for a thermal plant.

The object of the invention is achieved by vessel lids according to the features of the enclosed independent claims. Preferred embodiments are defined by the dependent claims.

The lids according to the invention involve the inventive idea to improve the sealing between the vessel lid and the vessel wall by a vertical adjustment and/or tilting of the vessel lid or of individual lid parts of the vessel lid. It is also encompassed by the inventive idea to construct the vessel lid such that the vessel lid or individual lid parts can be removed and, if applicable, can be replaced without interrupting the operation.

A vessel lid or a vessel cover for a large vessel or container (in particular a thermal plant, as e.g. a melting furnace) is proposed, which consists of at least two lid parts. At least one of the lid parts is vertically adjustable and/or tiltable in relation to the large vessel. The term “large vessel” is understood to mean, inter alia, all containers that can be loaded with raw materials and for processing, transport and/or storage of these raw materials, or the processed products derived from raw materials. In case of a melting plant, these are for example the vessels in which the to be melted raw materials are melted and in which the melts are further processed, transported or conveyed (e.g. conveyor paths).

By vertical adjustment or tilting of the at least one lid part, the sealing of the lid parts between each other and/or the sealing of the vessel lid relative to the large vessel can be improved, for example by bringing the individual lid parts closer together, or by bringing the vessel lid as a whole closer to the inner wall of the large vessel.

In one embodiment, at least one of the lid parts is laterally displaceable relative to the large vessel. The laterally displaceable lid part can also be vertically adjustable and/or tiltable. However, the laterally displaceable lid part may also not be vertically adjustable and/or tiltable, and therefore another lid part is vertically adjustable and/or tiltable. The term “laterally displaced” includes both a linear (one-dimensional) displacement in a substantially horizontal plane as well as a two-dimensional movement in a substantially horizontal plane. A three-dimensional movement can be considered as a vertical adjustment coupled with a lateral displacement.

A lateral displacement can be achieved through for example a direct movement of the lid part, but also indirectly through a lateral displacement or a vertical adjustment or tilting of one or more other lid parts. A lateral displacement of a lid part can also result from a thermal load, e.g. due to thermal expansion of the lid part or of other (direct or indirect) adjacent lid parts.

In another embodiment the vessel lid comprises one or more first lid parts, which are vertically adjustable relative to the large vessel, and one or more second lid parts, which are laterally displaceable relative to the large vessel. The first lid parts and the second lid parts comprise first contact surfaces and second contact surfaces, respectively, which can be brought into contact with each other by vertical adjustment of the first lid parts and are configured such that a vertical adjustment of the first lid parts causes a lateral displacement of the second lid parts. The first and second contact surfaces may for example be configured with a wedge-shape. The movement of the laterally displaceable lid parts is thus indirectly achieved by the movement of the vertically adjustable lid parts.

In another embodiment, each lid part is vertically adjustable and/or laterally displaceable relative to the large vessel. This allows the lateral displacement or the vertical adjustment for each lid part to be determined individually. It may be provided that each lid part is both vertically adjustable and laterally displaceable. However, it can also be provided that some lid parts are only vertically adjustable while other lid parts are only laterally displaceable. Finally, it can also be provided that some lid parts are only vertically adjustable, other lid parts are only laterally displaceable and again other lid parts are both vertically adjustable and laterally displaceable.

In another embodiment, adjacent lid parts can be arranged such that the two lid parts partially overlap in vertical direction.

In another embodiment, each lid part comprises an outer contour, which is matched to the outer contour of at least one adjacent lid part such that the two lid parts can at least partially be slid into each other, such that the two lid parts overlap at least partially in vertical direction. Preferably one or more lid parts can be moved and thus slid into each other, such that one or more other lid parts no longer overlap with adjacent lid parts and can move freely in vertical direction.

The outer contours of the lid parts can be for example jagged (for example triangled or sawtoothed). The lid parts can also be joined together groove-and-tongue-like, for example by means of projections and corresponding indentations. This adaptation of the outer contours of lid parts can be achieved in either pairs or also in larger groups. It is also provided that all lid parts of the vessel lid comprise such outer contours that are mutually adapted.

In another embodiment, the mutually adapted outer contours of the lid parts are configured such that the lid parts are (e.g. laterally) displaceable, such that at least one lid part is movable upwards from the vessel lid. This allows to generate an access opening to the melting room. This also allows the exchange of individual lid parts. Such a configuration of the outer contours can be achieved for example by having the outer contours of the lid parts configured groove-and-tongue-like. With sufficient length of the groove-and-tongue-sections, little or partial overlap of the groove-and-tongue-sections already causes the two lid parts to at least partially overlap in vertical direction. Simultaneously, the lid parts can be also slid further into each other such that through lateral displacement of one or more lid parts, an opening in the lid can be achieved that is large enough to unobstructed vertically move a lid part (for example upwardly), and thus for removal from the lid.

In another embodiment, the vessel lid comprises at least two lid parts that are tiltable relative to each other. It is provided that the tilting of each tiltable lid part takes place independently of the other lid parts. However, it is also provided that the tilting of two (or more) lid parts is achieved through a common mechanism.

In another embodiment, the outer dimensions of the vessel lid are changeable between first outer dimensions corresponding substantially to the internal dimensions of the large vessel at a working position of the vessel lid in the interior of the large vessel, and second outer dimensions that are smaller than the smallest internal dimensions of the large vessel above the working position of the vessel lid in the interior of the large vessel, such that the vessel lid is upwardly movable from the large vessel. A vessel lid with the second outer dimensions facilitates the vessel lid to be moved into the interior of the large vessel, in particular if the opening of the upwardly open large vessel is smaller than the inner dimensions of the large vessel at the working position of the vessel lid. In order to thereafter improve the sealing of the vessel lid over the large vessel, the outer dimensions of the vessel lid can be increased according to the first outer dimensions.

In another embodiment, the outer dimensions of the vessel lid are changeable and adaptable to the internal dimensions of the large vessel at a working position of the vessel lid inside the large vessel to improve sealing of the vessel lid over the large vessel. This also makes it possible to improve the sealing between the vessel lid and the large vessel by substantially adapting the outer dimensions of the vessel lid to the inner dimensions of the large vessel at the working position of the vessel lid.

In another embodiment, the sealing of the lid parts between each other can be improved by vertical adjustment and/or tilting of the at least one lid part.

Also according to the invention, a vessel lid for a large vessel that is open at the top (in particular of a thermal plant) is provided, which is vertically adjustable and/or tiltable relative to the large vessel. In contrast to the aforementioned vessel lids, which consist of at least two lid parts which taken individually, are vertically adjustable, tiltable, laterally displaceable, etc., according to this aspect of the invention, the vessel lid is vertically adjustable and/or tiltable as a whole.

Vertical adjustment and/or tilting of the vessel lid can improve the sealing between the vessel lid and the large vessel. This is particularly the case when the inner wall of the large vessel has different inner dimensions at different heights. For example, with a partly circular inner wall of a large vessel, the vessel lid can be lowered to the extent that it comes as close as possible to the inner wall or even rests on the inner wall.

It is also provided by the invention that a vessel lid is composed of two or more lid parts, as described above, of which at least one is vertically adjustable and/or tiltable, such that such a vessel lid, in addition to the adjustability of the individual lid parts, is vertically adjustable and/or tiltable as a whole.

Furthermore, according to the invention, the vessel lid is configured to be arranged in the interior of the large vessel.

In another embodiment, the vessel lid comprises suction ducts and connections for an exhaust. In particular, it is provided that the suction ducts have at least one opening at the rim of the vessel lid, such that an exhaust (for example of exhaust gases) can be achieved directly at the gap between the lid and inner the wall of the vessel.

The invention also relates to an upwardly open large vessel (in particular, of a thermal plant), in which interior, a vessel lid, as described above and as will be described below, is arranged.

Furthermore, according to the invention, a vessel lid (or vessel cover) for a large vessel of a thermal plant, such as for example a melting furnace, with vessel walls that can be pushed through (as disclosed in European patent application EP 09752097) is provided, which is vertically adjustable and can therefore be adjustably arranged between worn vessel wall elements of the thermal plant. It is irrelevant to the invention, whether the vessel lid comprises an unequal extension in different directions (for example rectangular) or has a substantially rotationally symmetrical or polygonal extension. In addition to its vertical adjustability, the vessel lid can also be configured rotatable.

The maximum circumference of the vessel lid is smaller than or comprises smaller dimensions than said minimum inner circumference of the melting furnace or the interior of the melting furnace in the upper area of the worn vessel wall elements. Any resulting gap between the lid and the worn vessel wall elements can be adjusted by apertures that are arranged at the edge of the lid. All appropriate forms and technical embodiments of apertures are eligible for this. Because the vessel wall elements do not wear uniformly, it is necessary to determine the distance between the lid and the worn vessel wall elements in order to adjust the apertures as close as possible to the worn vessel wall elements, such that an optimal sealing of the melting furnace interior can be ensured. The sensors can also serve to control the feeding of the vessel wall elements in order to influence the resulting residual wall thickness of the worn vessel wall elements due to wear, by a change in feed rate and hence to influence the duration of the vessel wall elements in the melt. The apertures can provide sealants such as lips or brushes on their ends that face the vessel wall elements, such that a seamless alignment with the vessel wall elements is achieved. It is also possible to equip these sealants with pressure sensitive sensors, such that the apertures are moved up to the vessel wall elements until the pressure sensitive sensors emit a signal. This method is for example known as deactivation or jamming protection for gates. Also, other methods for measuring the gap between the lid and the vessel wall can be deployed, for example, optical methods such as laser distance measurement or by means of a thermal camera. Sensors which allow to determine the vertical position of the lid relative to the large vessel may also be provided. The data from the sensors can together with the data from the actuators, which are necessary for the feeding of the vessels wall elements, e.g. hydraulic pressure, be used for the operation of the thermal plant or of the melting furnace. Furthermore, data from sensors mounted in/on the wall elements, lid parts and/or base elements of the vessel, and/or are arranged on the units or the building of the melting plant, can be used to control/regulate the entire plant.

The lid can be provided with an exhaust, which sucks the substances emerging from the remaining gap between the apertures and the worn vessel wall elements, wherein the exhaust may be coupled with various separators. The exhaust can also be used to advantage when removing the worn vessel wall elements to prevent that fragments of these are passed into the melt. Dust/gases that emerge from the melt can also be removed by suction. Instead of an exhaust, the aperture and/or sealant may be replaced/supplemented by nozzles such that an air or medium stream provides a sealing of the melting furnace interior. Through a combined or separate injection of a medium, additional energy can be brought into the interior. The introduced mixture can be preheated and the load capacity of the top layer of the mixture can be increased, allowing more mixture to be introduced and thus increases the melting capacity.

The lid may be further provided with a mixture inlay. The mixture inlay can be either arranged below the lid, facing the melt, or the introduction of solids can take place through the lid, by means of apparatuses for insertion of the mixtures that are outside of the lid. If the mixture inlay is within the melting interior, it may be advantageous to protect the mixture inlay against produced heat during the heating of the melting furnace by a suitable apparatus. Several apparatuses for mixture inlay can be provided on the lid. The mixture can also be introduced into the melt through a gap between the lid edge and the vessel wall elements. By this way of the mixture introduction, the gap may be sealed.

The lid may comprise a grid, which is arranged between a bottom side of the lid and the melt. The grid may slow down mixtures that are inserted through the lid and, if applicable, distribute these mixtures over the top layer of the mixture by suitable openings combined with a vibration function of the grid. The introduced mixture thus first falls on the grid and from there with low fall onto the top layer of the mixture. It is therefore advantageous if the grid is configured to be adjustable. Furthermore, the grid can be arranged such, that at a certain thickness of the top layer of the mixture it resides therein, thereby contributing to the stabilization of the top layer of the mixture. This is advantageous for the melting process.

Since it may be that upon heating of the melting furnace no worn vessel wall elements are present, the lid can be vertically adjusted such that it can be fitted onto and sealing the upper vessel wall elements. When the uppermost unworn vessel wall elements are removed and worn vessel wall elements as upper vessel wall elements are adjacent to the lid, the lid may be vertically adjusted in the direction of the melt, and the larger gap, resulting from the wear of the vessel wall elements, can be adjusted through the apertures, as described above.

Through the lid an agitator can be passed, which moves the melt in order to achieve better mixing. When heating or in the case of a revision, it can be advantageous to be able to withdraw the agitator from the melting interior through the lid. Several agitators can be provided.

The agitator can be configured such that it has adjustable stirring elements, in which e.g. the inclination of a stirring blade can be adjusted. The agitator can be configured such that unmelted mixtures can be introduced into the interior by means of the agitator. This can be done over the entire length of the agitator and can extend over/under an existing grid. In addition, apparatuses may be attached to the agitator that favorably influence the distribution of the mixture in the interior. Also the mixture can be introduced directly into the melt by means of the agitator. Furthermore, the agitator can be configured such that energy can be introduced into the melt by means of the stirrer.

The lid can also be equipped with sensors (e.g. pressure and/or temperature sensors), as well as with connections and channels for conducting a cooling or heating medium, or for suction.

All features with reference to various embodiments mentioned above are independent and can (as far as possible) be optionally combined in an embodiment. In particular, the features of a vessel lid (or of a vessel cover) for a vessel with vessel walls that can be pushed through can be used for a vessel lid for a rotatable vessel with exchangeable wall elements. This applies in particular (but not limiting) for sealing elements, sensors and actuators (such as for example exhausts, nozzles, mixture inlays, grids, openings and agitators).

The vertical adjustment of the lid or individual lid parts or lid modules can be achieved by for example hydraulic elements, pneumatic elements, or actuators, etc. The drive elements for the vertical adjustment of the lid or individual lid parts or lid modules can preferably be fully automatic computer-controlled analog and/or digital and/or neurally regulated. The same applies to the possible need for lateral displacement of the lid or individual lid parts or lid modules.

Walls or wall elements and lid or lid parts or lid modules can be provided with openings for burners, exhaust, mixture inlay, sensors, measuring instruments, cameras, etc. These openings can be closed by lids or other closures, but can also remain open.

Although the invention is mainly presented with reference to melting furnaces (e.g. for melting of glass or metal), it is not limited to melting furnaces, but can also be deployed for example for transport vessels, storage vessels and conveyor paths (in particular not exclusively for melting) as well as in cement production and waste incineration.

With reference to the drawings, the invention will be explained below in detail. It shows:

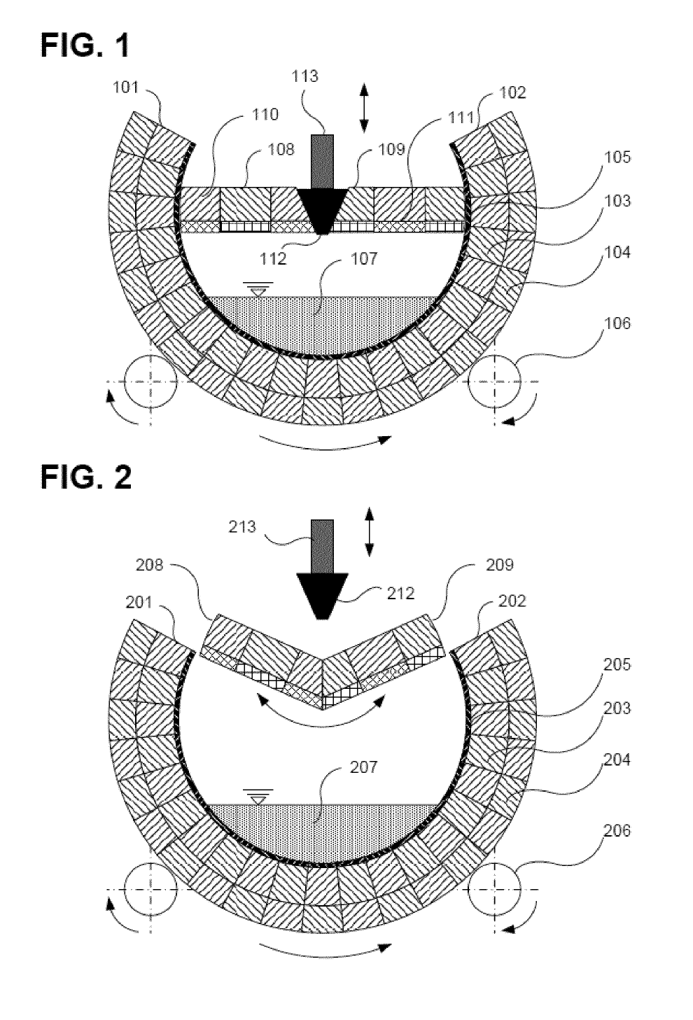

FIG. 1 an embodiment of a melting furnace having a lid with an improved sealing;

FIG. 2 an alternative of the embodiment of FIG. 1;

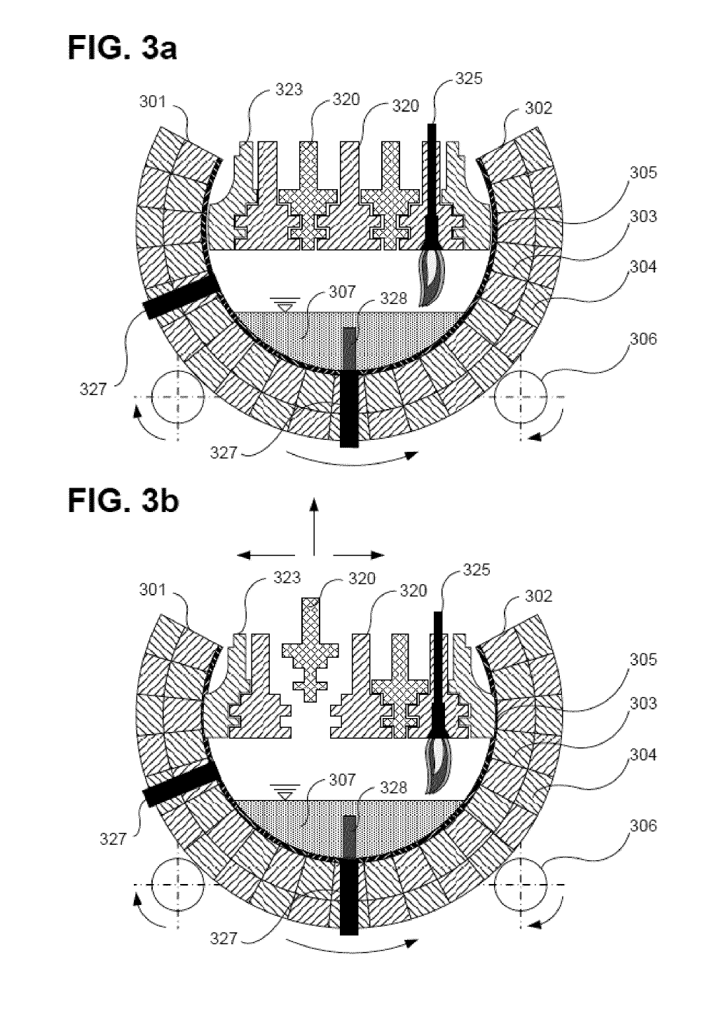

FIGS. 3a and 3b a further embodiment of a melting furnace with a lid having an improved sealing;

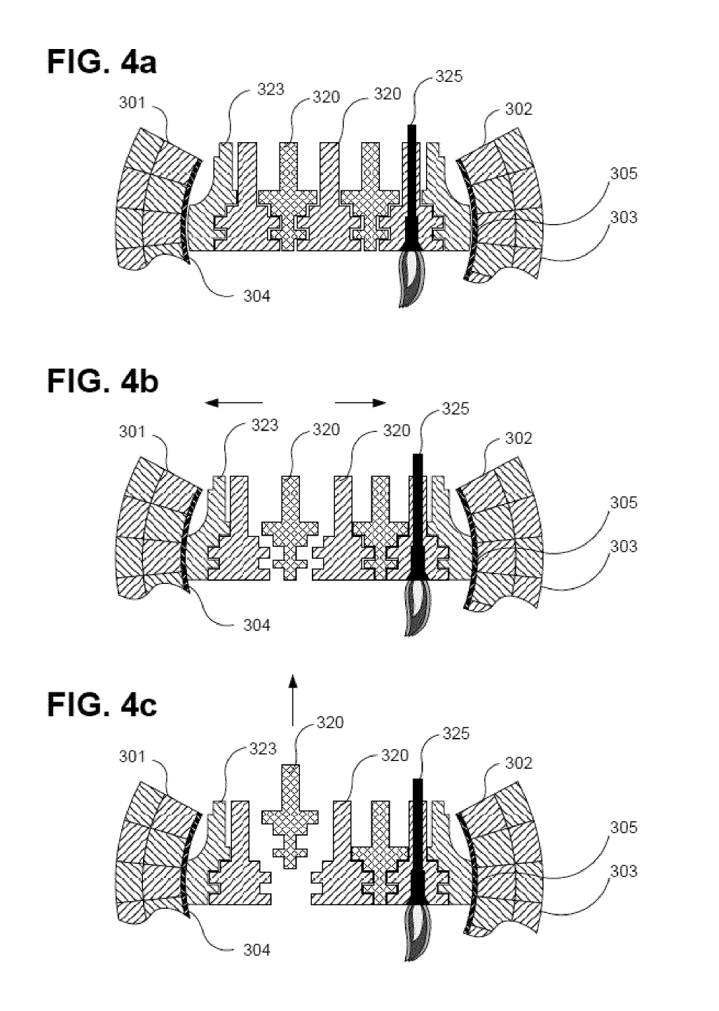

FIGS. 4a, 4b and 4c an enlarged view of the lid of the melting furnace according to FIG. 3;

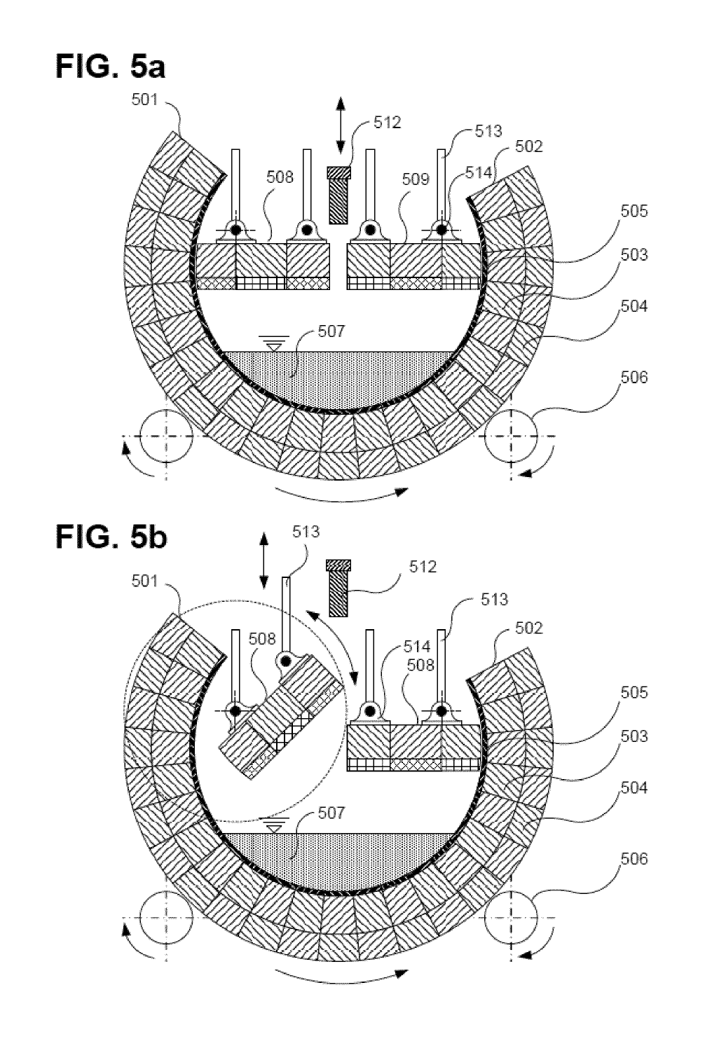

FIGS. 5a and 5b further embodiment of a melting furnace with a lid having an improved sealing;

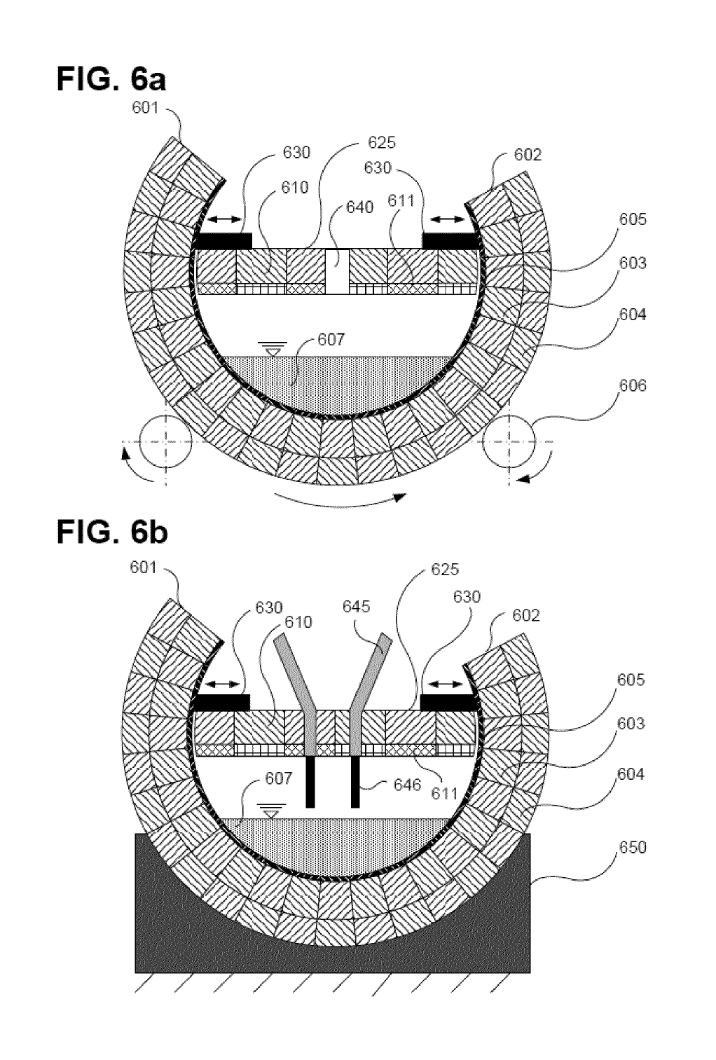

FIGS. 6a and 6b another embodiment of a melting furnace having a lid with displaceable apertures for improved sealing;

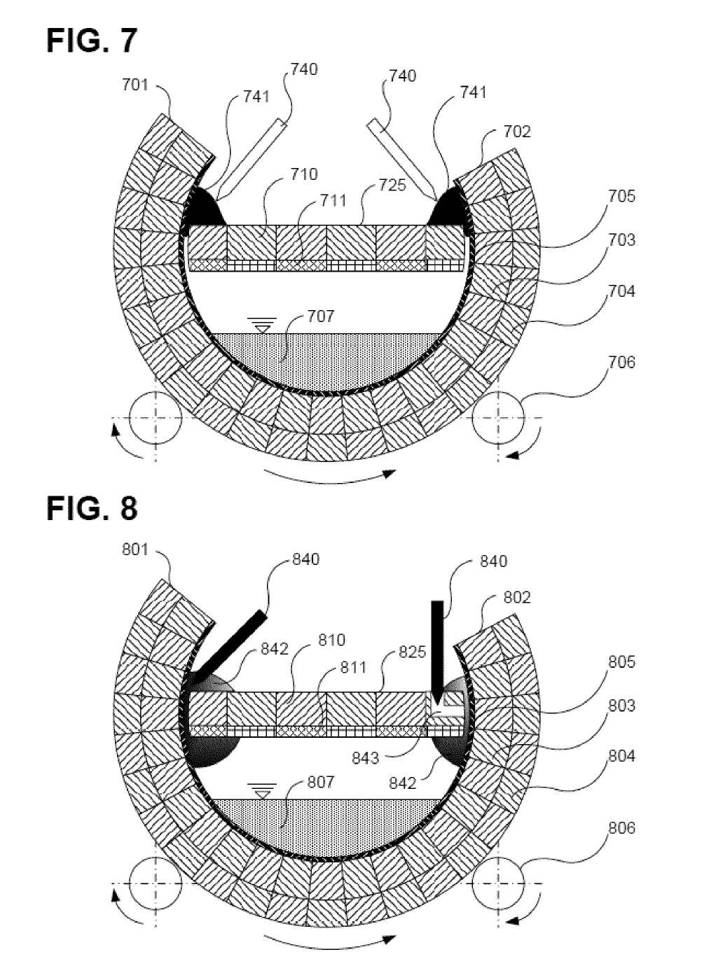

FIG. 7 a further embodiment of a melting furnace with a lid for improved sealing with a sealing compound;

FIG. 8 a further embodiment of a melting furnace with a lid for the improved sealing with (inert) gas;

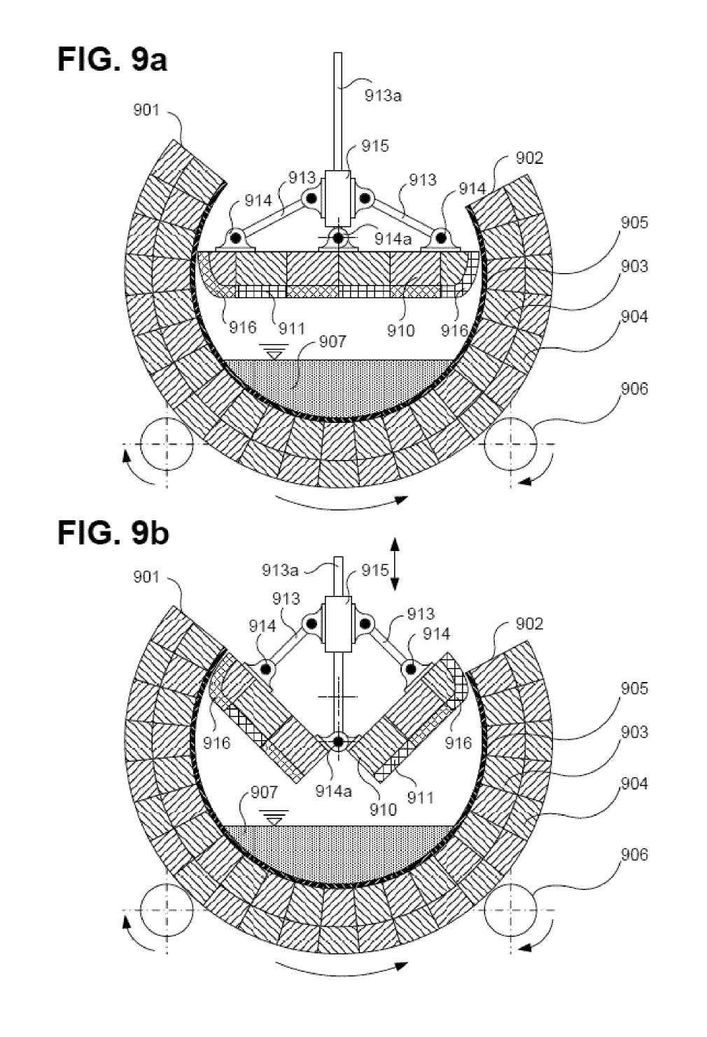

FIGS. 9a and 9b a further embodiment of a melting furnace with a lid for the improved sealing with tiltable lid parts;

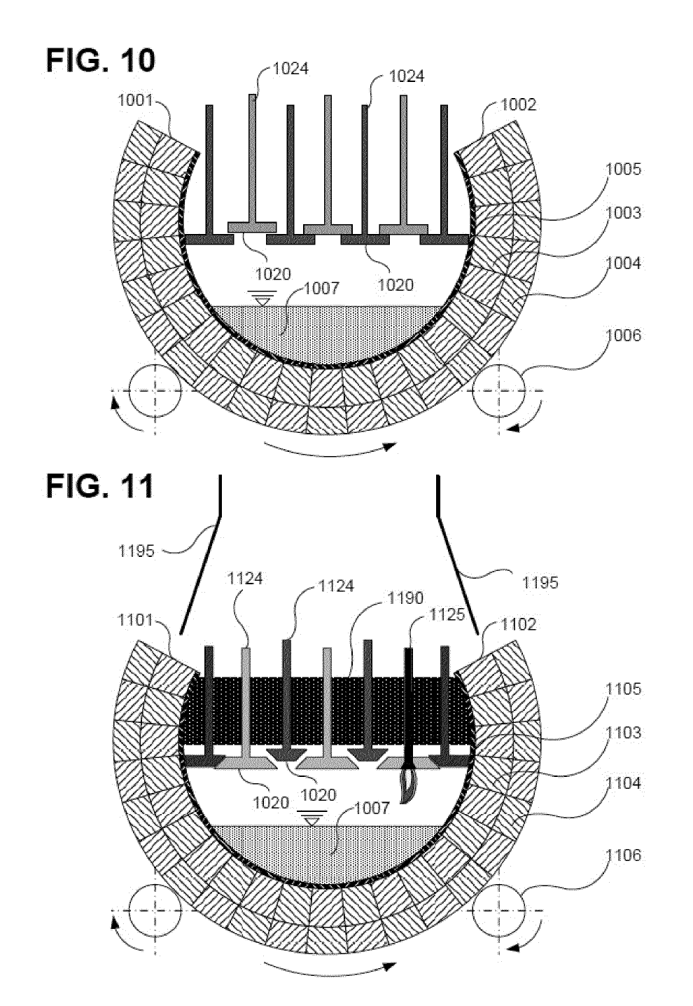

FIG. 10 a further embodiment of a melting furnace with a lid with improved sealing;

FIG. 11 a further embodiment of a melting furnace with a lid with improved sealing with an insulation layer;

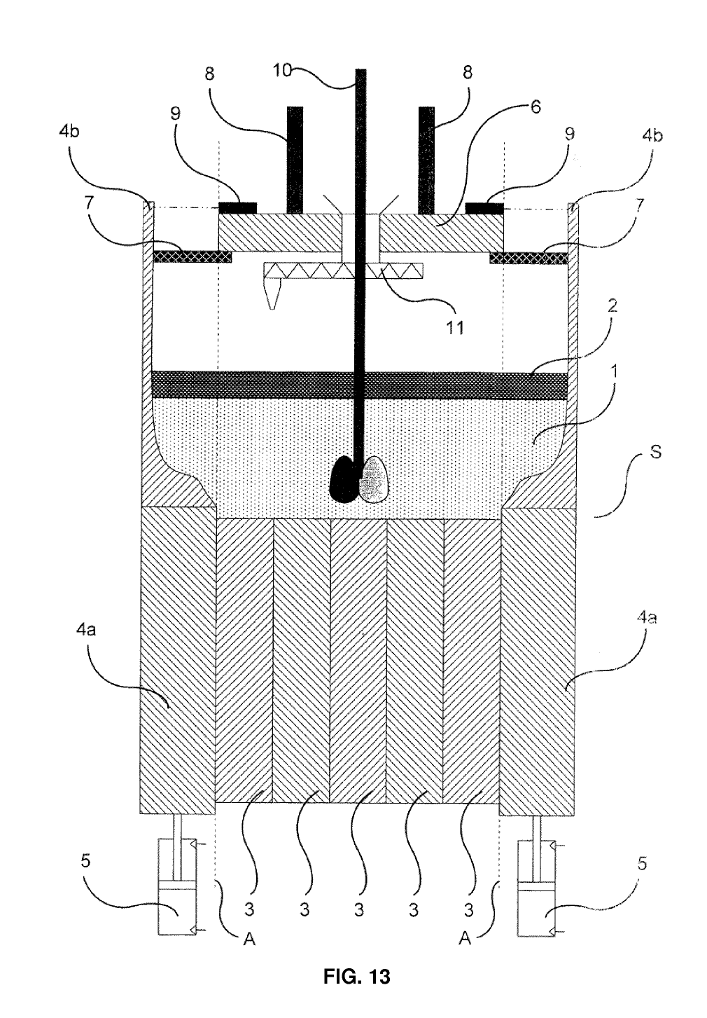

FIG. 13 is a sectional view of a melting furnace with an adjustable lid, fixtures and vessel wall elements that can be pushed through;

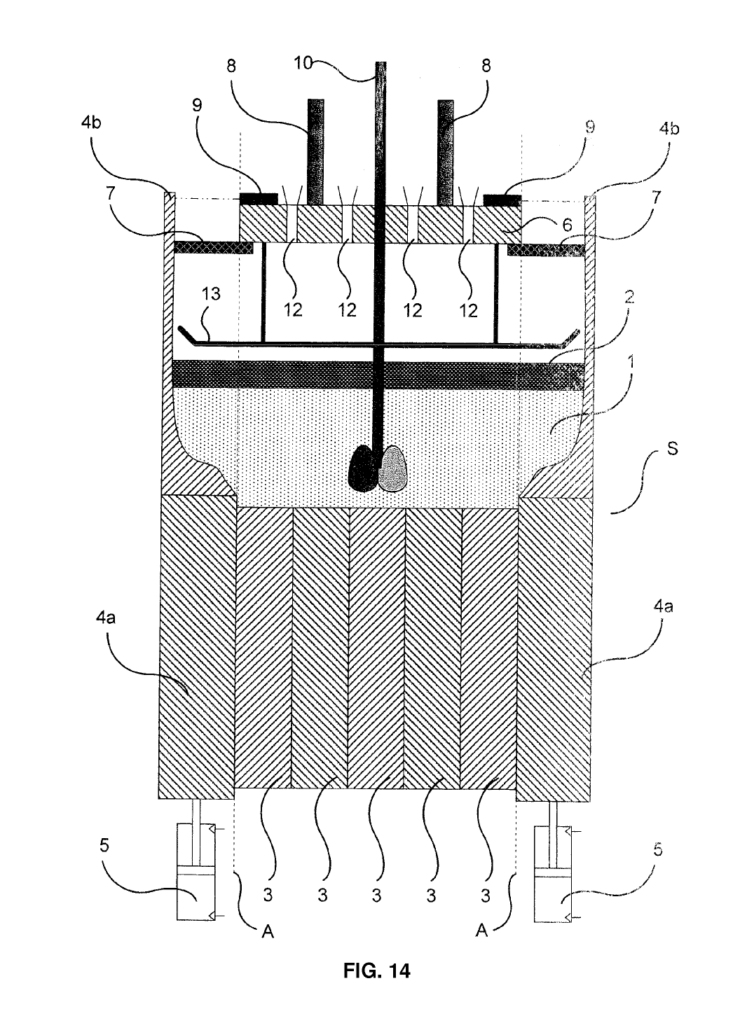

FIG. 14 is a sectional view similar to FIG. 13 of a melting furnace with adjustable lid, fixtures and vessel wall elements that can be pushed through.

According to the embodiment of FIG. 1, a section through a melting furnace is recognized, which is constructed from exchangeable wall elements 101, 102. Each of the elements consists of a continuous layer 103, an insulation layer 104 and a wearing course layer 105. The wall elements form a partial circle at which one end new, unused wall elements 101 may be attached, and at which other end the worn wall elements 102 whose wearing course layer has been (partly) worn for example by contact with the melt 107, can again be removed.

The vessel formed by the wall elements is, for example, mounted on rollers 106, which are actuated continuously or periodically to rotate the vessel. Such a melting furnace is also shown in FIGS. 2-6A and 7-11 (with reference numerals adapted to the figure) and is therefore not described in more detail in these figures.

The melting furnace according to FIG. 1 is provided with a lid, which is arranged in the interior of the melting furnace. The lid consists of two substantially horizontally extending lid parts 108, 109 and a wedge-shaped lid part 112, which is arranged between the two horizontal lid parts 108, 109. The two horizontal lid parts 108, 109 can in this case be, for example, configured as continuous elements, each mounted to a support (not shown) via a suspension (not shown). The lid parts 108, 109 may also consist of a plurality of lid parts that are connected either permanently or detachably to each other or are each mounted to a support (not shown) via a suspension (not shown). The horizontal elements of lids 108, 109 (or these lid parts constituting lid elements) and/or the wedge-shaped lid part 112 may also consist of a multilayered structure. These lid elements can for example consist of a carrier layer 110 and a wearing course layer 111.

The wedge-shaped lid part 112 is mounted via a variable suspension 113 to a support, such that through the variable suspension 113, a vertical adjustment of the wedge-shaped lid part 112 is provided, i.e. that a movement of the wedge-shaped lid part 112 in the vertical direction is possible.

The contact areas between the two horizontal lids 108, 109 and parts of the wedge-shaped lid part 112 can be adjusted to each other. For example, these contact areas (or contact surfaces) are obliquely arranged such that by a vertical adjustment of the wedge-shaped lid part 112 (after it has been brought into contact with the two horizontal lid parts 108, 109) also a laterally directed force acts on the horizontal lid parts 108, 109, causing them to be laterally displaced. By this displacement, the horizontal lid parts 108, 109 can be moved close to the inner wall, that is, be moved closer to the wearing course layer 105. Depending on the wedge angle of the wedge-shaped lid part 112 and the accordingly adjusted contact surfaces of the horizontal lid parts 108,109, a very fine adjustment of the distance between the horizontal lid parts 108, 109 and the inner wall of the vessel is thus possible. The smaller the wedge angle, i.e. the closer the contact surfaces on the vertical, the lower the lateral displacement of the horizontal lid parts 108, 109 caused by a given vertical adjustment of the wedge-shaped lid part 112 will be, and vice versa.

It is thus possible to optimize the sealing between the horizontal lid parts 108, 109 and the inner wall of the vessel. The sealing between the wedge-shaped lid part 112 and the two horizontal lid parts 108, 109 is ensured by the pressure of the wedge-shaped lid part 112 on the horizontal lid parts 108, 109.

FIG. 1 shows that the vessel opening, which is determined by the horizontal distance between the two wall elements 101, 102 at the two ends of the partial circle which forms the vessel wall, is smaller than the horizontal extension of the lid in the interior of the vessel. In order to nevertheless allow the mounting of the lid in the interior of the vessel, the two horizontal lid parts 108, 109 can, for example, initially be introduced independently into the vessel interior. The horizontal dimension of each of the lid parts 108, 109 is smaller than the vessel opening, so that these can be easily introduced into the vessel interior. After the two horizontal lid parts 108,109 have been arranged and suspended inside the vessel, the wedge-shaped lid part 121 can also be introduced into the vessel interior.

Subsequently, the horizontal extension of the entire lid, i.e. the lid consisting of the two horizontal lid parts 108, 109 and the wedge-shaped lid part 112, can, as described above, by means of a vertical adjustment of the wedge-shaped lid part 112, occur according to the dimensions of the interior of the vessel at the working position selected for the vessel lid (i.e. at the desired height). Due to the arrangement of the vessel lid in the interior of the vessel, a good sealing between the vessel lid and the inner wall of the vessel is also possible in case of a rotating vessel.

Instead of separately introducing the two horizontal lid parts 108, 109 into the container, it is also possible to introduce the two lid parts simultaneously. Such a case is shown for example in FIG. 2. In this embodiment the two horizontal lid parts 208, 209 are interconnected by (not shown) connecting elements. The connecting elements allow the two horizontal lid parts 208, 209 to tilt against each other and/or to slide against each other. In the position of the horizontal lid parts 208, 209, which is shown in FIG. 2, the horizontal extent of the two lid parts 208, 209 is reduced relative to a position of the horizontal lid parts 208, 209, in which the two lid parts 208, 209 are each arranged horizontally. This allows to introduce the two horizontal lid parts 208, 209 in the tilted position through the vessel opening into the vessel interior.

In the interior of the vessel, the horizontal lid parts 208, 209 can then be folded out, such that both lid parts 208, 209 are arranged horizontally. In the resulting wedge-shaped intermediate space between the two lid parts 208, 209 the wedge-shaped lid part 212 can then be inserted by a vertical movement. Preferably, the contact areas (contact surfaces) of the wedge-shaped lid part 212 are adjusted to the contact surfaces (contact surfaces) of the two horizontal lid parts 208, 209, as already described in FIG. 1. Through a vertical adjustment (vertical displacement) of the wedge-shaped lid part 212—again according to the description of FIG. 1—both horizontal lid parts 208, 209 can be displaced laterally. The horizontal lid parts 208, 209 thereby can again be brought close to the vessel inner wall, whereby the sealing between the vessel lid and the vessel inner wall can be improved.

Similar to FIG. 1 also here the two horizontal lid parts 208, 209 are mounted by a suspension (not shown) to a support (not shown). Similarly, the wedge-shaped lid part 212 is mounted by a vertically movable suspension 213 to a (not illustrated) support.

FIGS. 3a and 3b show again a melting furnace constructed from exchangeable wall elements. The structure and operation of the rotating melting furnace corresponds to the melting furnaces shown in the figures discussed above. The melting furnace according to FIGS. 3a and 3b is also provided with a lid which is arranged in the interior of the vessel of the melting furnace and which is shown enlarged in FIGS. 4a, 4b and 4c again.

The lid consists of a plurality of individually suspended lid parts 320 each capable to be moved laterally and vertically adjustable. The suspension of the lid parts 320 on a support is not shown here. The outer contours of each of two adjacent lid parts 320 are adapted to each other such that the adjacent lid parts 320 may be partially slid into each other. Through configuration of the outer contours with protrusions and indentations, i.e. groove-and-tongue-like, adjacent lid parts 320 can be slid into each other such that these lid parts are arranged in a partially overlapping vertical direction.

Sealing of the individual lid parts 320 between one another can be achieved for example by vertically adjusting every second lid part, such that the contact surfaces of two adjacent lid parts 320 touch each other in the overlapping area. The lid parts 323 which are arranged at the edge of the lid have an outer contour, which is adapted to the adjacent lid part and to the outer contour of the wall. This way it is possible to bring the edge lid parts 323 close to the inner wall of the vessel, thereby achieving a good sealing between the lid and the inner wall of the vessel.

As can be seen in FIG. 4a, an overlap of the lid parts 320 in the vertical direction can already be achieved if adjacent lid parts are only partially slid into each other. Thereby, it is possible to push the lid parts 320 even further together than would be required for a mere cover of the vessel interior. This is illustrated in FIG. 4b. Through further continuous pushing together of the lid parts 320 it can be achieved, that a lid part in the vertical direction does not overlap with any other lid part. This allows, as shown in FIG. 4c, to now remove in the vertical direction and if necessary replace the now detached lid part. The insertion of the same or a new lid part then occurs in the reverse direction. For this purpose, the remaining lid parts (if necessary) are again slid into each other such that an opening in the lid for the new lid part is formed (FIG. 4c). The lid part to be inserted is then lowered into this opening (FIG. 4b). Subsequently all the lid parts are laterally displaced such that between each two adjacent lid parts an overlap in the vertical direction exists (FIG. 4a). Then, again by a vertical adjustment of individual lid parts (for example, every second lid part), a sealing of the lid parts between each other is achieved.

In FIGS. 3a, 3b and 4a, 4b, 4c three types of lid parts are shown: the edge elements 323 and two different lid parts 320 on the inside of the lid. The inner elements 320 are symmetrically configured, i.e. they comprise on both sides the same outer contour, so that always two different inner elements 320 are arranged side by side. It is also provided that the inner elements are not configured symmetrically, but comprise different outer contours on both sides. If the different outer contours are then configured to fit the “left” outer contour of a first inner element to the “right” outer contour of an adjacent second inner element, it is for example possible to configure all inner elements the same. It is also possible to provide more than two different configurations of the inner elements.

In FIG. 3a it is also shown that one of the lid parts 323 is provided with an opening, into which a burner 325 is employed to heat the melt. Also shown in FIG. 3a, is that two wall elements are provided with electrode holders 327, in which electrodes 328 are arranged to heat the melt. As electrodes molybdenum electrodes can be used for example. It may be that the electrodes for heating the melt are not allowed to come into contact with oxygen. In order to prevent contact of the electrodes with oxygen as long as the rotation of the vessel wall is not yet so advanced that the electrode is immersed into the melt, it may be provided that the electrodes are arranged in the interior of the sealed electrode holder, as long as the wall element in question is not in contact with the melt. For example, in case of a glass melt the sealing of the electrode holder can be conducted with a glass plug, which melts when it comes into contact with the glass melt. It can be provided that the electrode in the interior of the electrode holder is pressed against the glass plug, so that the electrode is pushed at least partially out of the electrode holder and comes into contact with the melt when the glass plug melts.

Although both the electrodes as well as a burner for heating the melt are shown in FIG. 3a, it is not necessary that both heating facilities are equally used. In particular, it is also possible that the melt is heated only by the burner. Furthermore, it is also possible that the melt is heated only by electrodes. The heating elements (burner, electrodes) shown in FIG. 3a can also be used in the other above and below described embodiments, in which no heating elements are shown.

The representation according to FIGS. 5a and 5b in turn shows a melting furnace constructed from removable wall elements. The structure and operation of the rotating melting furnace correspond to the melting furnaces shown in the figures discussed above. The melting furnace according to FIGS. 5a and 5b is also provided with a lid, which is arranged in the interior of the vessel of the melting furnace.

The lid consists of two substantially horizontally extending lid parts 508, 509 and another lid part 512 disposed between the two horizontal lid parts 508, 509 and which closes the gap between the two horizontal lid parts 508, 509. The two horizontal lid parts 508, 509 can thereby, for example, be formed as continuous elements, which are each mounted through a suspension 513, 514 (not shown) to a support (not shown). The lid parts 508, 509 may also consist of a plurality of lid parts that are either permanently or detachably connected to each other or which are each mounted separately through a suspension to a support. The horizontal lid parts 508, 509 (or these lid parts constituting lid elements) and/or the additional lid part 512 can be constructed from multiple layers. For example, these lid parts can consist of a carrier layer 510 and a wearing course layer 511.

Said further lid part 512 is mounted via a (not shown) variable suspension to a (not shown) support such that a vertical adjustment of said further lid part 512 is provided by the variable suspension.

The suspension can for example take place by rods 513, which are mounted by hinges 514 to the horizontal lid parts 508, 509. The rods 513 may for example lead to (not shown) hydraulic elements or be part of hydraulic elements. Although it is shown in FIGS. 5a and 5b, that each of the two horizontal lid parts 508, 509 is suspended by two rods 513, the suspension can, as required, take place with more than two rods 513 (for example dependent on the size of the lid parts 508, 509).

The suspension of the horizontal lid parts 508, 509 through rods 513 and hinges 514 also allows to tilt the horizontal lid parts 508, 509. This is illustrated in FIG. 5b. By tilting it is facilitated to insert or remove the horizontal lid parts 508, 509 into or from the interior of the vessel, respectively. To enable the tilting of the horizontal lid parts 508, 509, said further lid part 512 can be upwardly removed beforehand. The resulting gap between the two horizontal lid parts 508, 509 then allows one or both of the horizontal lid parts 508, 509 to tilt.

In the position of the lid part 508, shown in FIG. 5b, the element can not be simply pulled out upwardly from the interior of the vessel since it is obstructed by a wall element 501. To allow for removal of the lid part, the tilting of the lid part 508 can be increased to further reduce the horizontal extent of the lid part 508. It would also be possible, to remove the lid part 508 from the interior of the vessel by moving it upwards and laterally by a combination of movements. Furthermore, the wall of the melting furnace could be rotated further so that the wall element 501 no longer prevents the upward removal of the lid part 508. It would also be possible to remove the wall element 501, remove the lid part 508 and reposition the wall element 501 again. The preferred procedure for removing a lid part (or an entire lid) is inter alia dependent on the opening angle of the vessel.

The sealing between the horizontal lid parts 508, 509 and the inner wall of the vessel can be achieved for example by a vertical adjustment of the horizontal lid parts 508, 509. The horizontal lid parts 508, 509 are accommodated to a height, in which they are as close as possible to the inner wall of the vessel, whose internal dimension varies with height. The sealing between the two horizontal lid parts 508, 509 is then achieved by the further lid part 512.

The representation according to FIGS. 6a and 6b, shows a melting furnace constructed from exchangeable wall elements. The structure and operation of the rotating melting furnace correspond to the melting furnaces shown in the figures discussed above. The melting furnace according to FIGS. 6a and 6b is also provided with a lid 625, which is arranged in the interior of the vessel of the melting furnace.

The lid 625 can be configured either as a continuous lid, which extends over the entire surface to be covered, or it can consist of a plurality of lid parts that are fixed or detachably connected to each other. The lid of 625 (or the individual lid parts) can also be constructed from multiple layers. For example, the lid can consist of a carrier layer 610 and a wearing course layer 611.

The lid 625 may be vertically adjustable. By vertical adjustment through a (not shown) variable suspension to a (not shown) support, the lid in the interior of the vessel can be brought in close proximity to the vessel inner wall to improve the sealing. Moreover, the lid comprises on both sides apertures 630, which can cover a potentially remaining gap between the lid 625 and the inner wall of the vessel. The apertures 630 may be moved horizontally along the lid 625, to optimally adjust its position with respect to the inner wall of the vessel. The apertures 630 may be formed for example of a softer material than the lid 625, to bring the apertures in direct contact with the inner wall in order to optimize the sealing between the lid and the vessel inner wall. Because of the softer material of the apertures 630, the wear of the wearing course layer 605, which occurs upon a rotation of the vessel around the fixed lid, is reduced at the inner vessel wall. If wear of the apertures 635 occurs due to this rotation, the resulting gap between the inner wall of the vessel and apertures 635 can be closed again by lateral displacement of the apertures 635.

It is also possible to arrange the lid 625 at a fixed height and to achieve the sealing of the lid between the inner wall of the vessel only via the apertures 630 as described above.

The lid shown in FIG. 6a has an opening 640, which is suitable for observing the melt, for insertion of mixtures, for the insertion of sensors, etc. If desired, it is possible to close the opening 640 with a (not shown) lid, when the opening 640 is not required, thereby avoiding thermal loss. Such an opening can also be used in the lids as shown in the other figures.

The lid shown in FIG. 6b comprises openings in which the electrode holder 645 is arranged with electrodes 646 held therein. The electrodes 646 are used to heat the air above the melt 607. For example, graphite electrodes can be used for this purpose. Alternatively, it is provided (but not shown here) that the electrode holder extends below the lid 625, and into the melt 607. Electrodes, which should not come into contact with oxygen, can then also be used as heating elements for the melt. Such electrode arrangements may be used also in the lids as shown in the other figures.

It is also shown in FIG. 6b that not the entire vessel wall must be rotated. In this alternative embodiment of the vessel the vessel wall is composed of a fixed furnace tub, which rests on a tub fixture 650, and an inner wearing course layer 605, which can rotate relative to the fixed furnace tub (consisting of a continuous layer 603 and an insulating layer 604). Such a configuration of the vessel can also be used in the vessels shown in the other figures.

Since the horizontal extension of the lid 625, when the lid 625 is made of one continuous piece, can be larger than the opening of the vessel between the two ends 601, 602 of the partial circle formed by the vessel wall, the lid 625 cannot simply be lowered from above into the interior of the vessel. In this case, the modular construction of the vessel of the melting furnace from individual wall elements provides a further advantage. Namely, it is possible, to initially construct the vessel of the melting furnace only partially from wall elements so that the vessel opening is initially large enough to introduce the lid into the interior of the vessel. After the lid is arranged at the desired location, the vessel wall can be completed by attaching additional wall elements. Such an approach is not only possible in the embodiment of FIG. 6, but can also occur if desired or necessary, in the other above-described melting furnaces.

The representation according to FIG. 7 again shows a melting furnace constructed from exchangeable wall elements. The structure and operation of the rotating melting furnace correspond to the melting furnaces shown in the figures discussed above. The melting furnace according to FIG. 7 is also provided with a lid 725, which is arranged in the interior of the vessel of the melting furnace.

The lid 725 can be configured either as a continuous lid which extends over the entire surface to be covered, or it can consist of a plurality of lid parts that are fixed or detachably connected to each other. The lid of 725 (or the individual lid parts) can also be constructed from multiple layers. For example, the lid can consist of a carrier layer 710 and a wearing course layer 711.

The lid 725 may be vertically adjustable. By vertical adjustment through a (not shown) variable suspension to a (not shown) support, the lid in the interior of the vessel can be brought in close proximity to the vessel inner wall to improve the sealing. Moreover, the possibly remaining gap between the lid 725 and the inner wall of the vessel gap can be covered by a sealing compound 741, which is injected from a source 740 in the direction of the remaining gap. When contact between the sealing compound 741 and the inner wall of the vessel is lost or reduced, due to rotation of the vessel (or for other reasons), and thus the sealing of the lid 725 relative to the inner wall of the vessel is deteriorated, further sealing compound 741 can be injected from a source 740 to improve the sealing.

It is also possible to arrange the lid 725 at a fixed height and to achieve the sealing of the lid between the inner wall of the vessel only via the sealing compound 741 as described above.

The illustration in FIG. 8 again shows a melting furnace, which is composed of exchangeable wall elements. The structure and operation of the furnace correspond to the rotating furnaces shown in the figures discussed above. The melting furnace according to

FIG. 8 is also provided with a lid 825, which is arranged in the interior of the vessel of the melting furnace.

The lid 825 can be configured either as a continuous lid which extends over the entire surface to be covered, or it can consist of a plurality of lid parts that are fixed or detachably connected to each other. The lid 825 (or the individual lid parts) can also be constructed from multiple layers. For example, the lid can consist of a carrier layer 810 and a wearing course layer 811.

The lid 825 may be vertically adjustable. By vertical adjustment through a (not shown) variable suspension to a (not shown) support, the lid in the interior of the vessel can be brought in close proximity to the vessel inner wall to improve the sealing. Moreover, the possibly remaining gap between the lid 825 and the inner wall of the vessel gap can be covered by a (inert) gas 842, which has for example a poor thermal conductivity. The gas 842 can be brought to the gap between the lid 825 and the inner wall of the vessel through supply lines 840. In a possible variant (shown in FIG. 8, left) the gas 842 is passed through the supply lines 840 directly into to the gap between the lid 825 and the inner wall of the vessel. In another possible variant (shown in FIG. 8, right), the gas 842, is led by the supply lines 840 into a line 843, which is located within the lid 825. The line 843 comprises an opening on the outer side of the lid 825 so that the gas 842 can be passed from line 843 directly into the gap between the lid 825 and the inner wall of the vessel.

The two variants shown in FIG. 8 do not need to be used in a single lid. For example, for a lid only the variation of the direct supply of the gas to the gap can be used on both sides, or only the variation to supply the gas via a line within the lid can be used on both sides.

The rate at which the gas is supplied to the gap is determined by the rate at which the gas again leaves the gap between the lid and the interior wall of the vessel by diffusion or other causes.

It is also possible to arrange the lid 825 at a fixed height and to achieve the sealing of the lid against the inner wall of the vessel only via the feed gas 842 as described above.

It is also contemplated that the supply lines 840 shown in FIG. 8 and lines 843 are not used for the supply of a gas, but for example, for suction of exhaust gases that may escape through the gap between the lid 825 and the inner wall of the vessel.

The representation according to FIG. 9 again shows a melting furnace constructed of exchangeable wall elements. The structure and operation of the rotary furnace correspond to the furnaces shown in the figures discussed above. The melting furnace according to FIG. 9 is also provided with a lid, which is arranged in the interior of the vessel of the melting furnace.

The lid consists of two substantially horizontally extending lid parts 908, 909. The two horizontal lid parts 908, 909 can be configured, for example, as continuous elements. Both lid parts can be mounted via a suspension 913, 914 to a support (not shown). The lid parts 908, 909 can also be constructed from multiple layers. For example, the lid can consist of a carrier layer 910 and a wearing course layer 911.

The two lid parts 908, 909 each comprise two hinges 914, 914a. The two inner hinges 914a are suspended on a vertically adjustable central pipe 913a. The two outer hinges 914 are also connected via pipes 913 with a slider 915 through hinges. The slider 915 is arranged on the central pipe 913a and is slideable with respect to this. By moving the slider 915 with respect to the central pipe 913a the inclination of both lid parts 908, 909 can be adjusted. It is thus possible to fold the lid, which in its non-tilted position, i.e. in a horizontal extension, comprises a greater dimension than the opening of the vessel, allowing the lid to pass through the vessel opening for insertion into or removal from the vessel interior.

The sealing between the horizontal lid parts 908, 909 and the inner wall of the vessel can be achieved for example by vertical adjustment of the lid, for example by hydraulic height adjustment of the center pipe 913a. The lid is placed on a height at which it is as close as possible to the inner wall of the vessel, whose inner dimension is variable with height.

To remove the lid from the interior of the vessel, it is first lowered, preferably by means of a height adjustment of the central pipe 913a. Then it is possible, to tilt the two horizontal lid parts 908, 909 by an upward movement of the slider 915 along the central pipe 913a, such that the horizontal extent of the “collapsed” lid is smaller than the vessel opening. The side edges 916 of the two lid parts 908, 909 are rounded as required, to allow tilting of the lid parts 908, 909. The required rounding of the side edges 916 and the required vertical shift also depends on the opening angle of the vessel wall.

The representation according to FIG. 10 shows a melting furnace constructed from exchangeable wall elements. The structure and operation of the rotating furnace correspond to the melting furnaces shown in the figures discussed above. The melting furnace according to FIG. 10 is also provided with a lid which is arranged in the interior of the vessel of the melting furnace.

Similar to the lid as shown in FIGS. 3a, 3b and 4a, 4b, 4c, the lid according to FIG. 10 consists of a plurality of individually suspended lid parts 1020, each of which are laterally displaceable and also vertically adjustable. The suspension of the lid parts 1020 through the support rods 1024 on a support is not shown here. Adjacent lid parts 1020 can be arranged to overlap in the vertical direction.

A sealing of the individual lid parts 1020 between one another can be achieved for example by the fact that every second lid part is vertically adjustable such that the contact surfaces of two adjacent lid parts 1020 touch each other in the overlapping area. The sealing between the lid as a whole and the vessel wall can be achieved for example by a common vertical adjustment of all lid parts 1020. The lid is placed on a height at which it is as close as possible to the inner wall of the vessel, whose inner dimension varies with height.

Another embodiment of the independently suspended lid parts is shown in FIG. 11. Here the lid parts 1120 are each beveled at the edge, such that for sealing of the lid parts 1120 between each other, a contact between each adjacent lid part 1120 may be achieved at the beveled edges.

FIG. 11 also shows that an insulation layer 1190 is arranged above the lid parts 1120. Above the vessel, an exhaust channel 1195 is arranged. The insulation layer 1190 is permeable to air but reduces the flow rate of the exiting air from the vessel into the exhaust duct 1195 to reduce heat losses (similar to the principle of a blanket). The lid parts 1120 serve as the reflector for radiant heat. The lid itself can likewise limit and control the volume flow of exiting air by opening and closing the lid by a vertical shift of the lid parts 1120.

The insulation layer 1190 may be constructed from a single or multiple layers. The insulation layer 1190 may for example consist of mineral wool. A multi-layer insulation layer 1190 may be made, for example, in the lower region of an air-permeable solid material and the upper part of mineral wool. It is also provided that the insulating layer 1190 consists in the horizontal direction of a plurality of individual elements, which are each associated with a lid part 1120 so that a lid part can be exchanged together with its associated insulation layer element.

The principle of the sealing of the vessel via an insulation layer shown in FIG. 11 can be used also in the embodiments shown in the other figures.

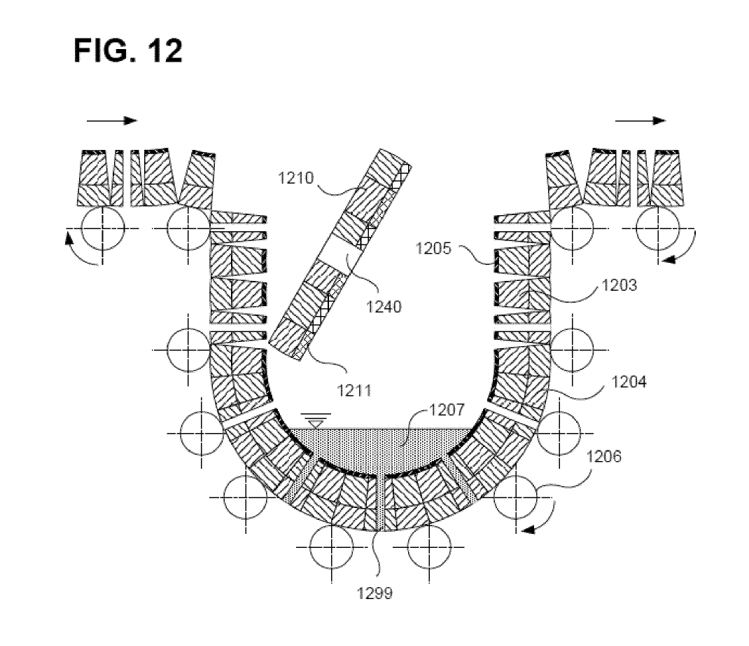

The figures described so far provide melting furnaces with a partly circular wall. However, the invention is not limited to such vessels. In FIG. 12, for example, another possible form of a vessel is shown, in which the vessel interior is configured substantially U-shaped. The wall of said vessel is constructed from a plurality of wedge-shaped wall elements which each consist of a continuous layer 1203, an insulation layer 1204, and a wearing course layer 1205. At the bottom of the vessel, the wedge-shaped wall elements lie close to each other, so that a substantially semi-circular region emerges in which melt 1207 is situated. The wall elements are provided in substantially straight lines, and are shifted by means of rollers 1206, which also provide for the rotation of the semi-circular lower portion. The wall elements can be interconnected by (not shown) connecting means on the broad outer surface (insulating layer 1204).

In the interior of the vessel there is a lid, which may consist of a plurality of interconnected lid elements as described above. The lid is mounted through a (not shown) suspension to a (not shown) support. The suspension allows to vertically adjust and/or tilt the lid. The lid shown in FIG. 12 comprises an opening 1240 that is suitable for observing the melt, for the introduction of a melt and/or mixture, for introducing a sensor, etc. If desired, it is possible to close the opening 1240 with a (not shown) lid. Such an opening can also be used in the lid as shown in the other figures.

Although in FIG. 12, the U-shaped vessel shape is shown with a one-piece lid, which can be tilted, this furnace shape may also be used with the lids in the other figures described above.

Every third wall element of what is represented in FIG. 12 has an orifice 1299 through which the melt 1207 can be removed if necessary. The orifices 1299 may possibly be closed by (not shown) closure apparatuses, for example, to allow the discharge of the melt 1207 only at certain times (e.g. only when an orifice 1299 is situated at the lowest point of the vessel). As long as the orifices are not located below the melt surface, this can also be used for other purposes, for example to introduce measurement and observation means or to introduce a mixture through the opening. It can also be that more or less wall elements than every third are provided with an orifice 1299. It can also be provided that the wall elements have more than just one orifice. Such orifices can be used in the other vessel walls in the figures described above.

A rotatable or movable vessel, as described above with reference to the previous figures, may be rotatable or movable not only in one direction, but may for example also be moved back and forth in both directions. This allows the flow to be influenced in the interior of the vessel and can, for example, achieve a better mixing.

As described above, walls and wall elements and lids and lid parts or lid elements can have a multilayer structure, for example with a continuous layer, an insulation layer and a wearing course layer or with a backing layer and a wearing course layer. Also other multilayer structures with more or fewer than the described layers are conceivable. In particular, a single-layer construction is possible. Also a wearing course layer is not necessarily required.

The lid may consist only of veneers, for example clinkers, coatings, coverings, etc., that are arranged for example on a support structure (such as for example a metal structure). Then it is possible to exchange only the veneers and re-use the support structure.

Preferably, the wall elements and the lid parts can be used repeatedly, optionally after an exchange or renewal of one or more layers. For example, the wall elements shown in the figures described above may be removed after one run through the vessel wall, can be provided with a new wearing course layer and then be re-inserted into the vessel wall (at the other side). Likewise, lid elements can be removed from the lid, be provided with a new wearing course layer and be reinstated in the lid.

The connection of the individual layers of the wall or lid parts between each other, can be achieved by denticulation, tension, wedging, screwing, etc. of the layers. Also, the wall or lid parts can be connected with each other by denticulation, tension, wedging, screwing, etc.

Depending on whether a relative displacement of the wall elements with each other or lid parts with one another needs to be possible, a corresponding connection is selected.

FIG. 13 shows a sectional view shown through a melting furnace S. The lower part of the melting furnace S consists substantially of base elements 3 and the vessel wall elements 4a and 4b. Here, the vessel wall elements 4b that are in contact with the melt 1 and a top layer of the mixture 2 are subject to wear and the vessel wall elements 4a are new or treated vessel wall elements, which are provided in a spaciously adjustable configuration and are fed from underneath. The feeding of the vessel wall elements 4a and 4b is generated by actuators, as illustrated by an embodiment of a hydraulic cylinder.

A lid 6 covers the melting furnace interior from the top. The lid 6 is mounted by vertically adjustable brackets 8. Adjustable apertures 7 are located on the sides of the lid 6. Also located on the sides of the lid 6 are sensors 9, which determine a distance between the sensor 9 on the lid 6 and the worn vessel wall elements. The lid 6 is dimensioned such that at most it extends to the not worn out vessel wall elements 4a, represented by line A. When the stones wear, the gap becomes larger and can be closed by the apertures 7.

Through the lid 6 an agitator 10 passes through which moves the melt 1 as needed. The agitator 10 is possibly retractable through the lid so as not to interfere with, for example, heating of the melting furnace S or taking damage thereof.

Furthermore, the lid 6 is provided with a mixture inlay 11. This brings the to be melted solid material into the melting furnace S. The mixture inlay 11 is arranged under the lid 6 of the melt 1.

The structure of the furnace in FIG. 14 corresponds substantially to the above described, whereby identical or similar parts are named with the same reference numerals for which reason their description is not provided again here. In the melting furnace S in FIG. 13 to be melted mixture is introduced through openings 12 in the lid 6 in the melting furnace S. A grid 13 disposed in the interior of the melting furnace S may distribute the mixture introduced through the openings and immerses with increasing thickness of the top layer of the mixture 2 therein, thereby bearing a portion of its weight. The grid 13 can also be adjusted vertically so that it can be inserted into the top layer of the mixture 2. The grid 13 is adjustably secured to the lid 6 and can be provided with suitable openings for vibrating distribution of the mixture.

The use of the lids described above is not limited to the vessel interior. The lids as described above may just as well be placed from above onto a vessel.

Although the present invention has been described with several embodiments, a person skilled in the art could consider various changes, substitutions, variations, alterations and modifications, and it is intended that the invention claims all such changes, substitutions, variations, alterations and modifications as they fall within the scope of the appended claims.

1. Vessel lid for an upwardly open large vessel, in particular of a thermal plant, characterized in that the vessel lid consists of at least two lid parts, wherein at least one of the lid parts is vertically adjustable and/or tiltable with respect to the large vessel.

2. Vessel lid according to claim 1, characterized in that at least one of the lid parts is laterally displaceable with respect to the large vessel.

3. Vessel lid according to claim 2, characterized in that the vessel lid comprises one or a plurality of first lid parts, which are vertically adjustable with respect to the large vessel, and comprises one or more second lid parts that are laterally displaceable relative to the large vessel, wherein the first lid parts and the second lid parts each comprise first contact surfaces and second contact surfaces that can be brought into contact with each other by a vertical adjustment of said first lid parts, and are configured such that a vertical adjustment of said first lid parts causes a lateral displacement of said second lid parts.

4. Vessel lid according to claim 2, characterized in that each lid part is vertically adjustable and/or laterally displaceable with respect to the large vessel.

5. Vessel lid according to one of claim 1, characterized in that the lid parts are arrangeable such that adjacent lid parts overlap at least partially in vertical direction.

6. Vessel lid according to one of claims 1, characterized in that each lid part has an outer contour adapted to the outer contour of at least one adjacent lid part such that the two lid parts are at least partially slideable into each other, so that the two lid parts at least partially overlap in the vertical direction.

7. Vessel lid according to claim 6, characterized in that the outer contours of the lid parts are configured such that the lid parts are displaceable in a way that at least one lid part is moveable upward from the vessel lid.

8. Vessel lid according to claim 1, characterized in that the vessel lid comprises at least two lid parts that are tiltable towards each other.

9. Vessel lid according to claim 1, characterized in that the outer dimensions of the vessel lid can be altered between first outer dimensions, which substantially correspond to the inner dimensions at a working position of the vessel lid in the interior of the large vessel, and second outer dimensions that are smaller than the smallest inner dimensions of the large vessel above the working position of the vessel lid inside the large vessel, so that the vessel lid is movable upward from the large vessel.

10. Vessel lid according claim 1, characterized in that the outer dimensions of the vessel lid can be changed and adapted to the inner dimensions of the large vessel at a working position of the vessel lid in the interior of the large vessel, in order to improve a sealing of the vessel lid with respect to the large vessel.

11. Vessel lid according claim 1, characterized in that the sealing of the lid parts between each other is improvable by vertical adjustment and/or tilting of the at least one lid part.

12. Vessel lid for an upwardly open large vessel, in particular a thermal plant, characterized in that the vessel lid is vertically adjustable and/or tiltable with respect to the large vessel.

13. Vessel lid according to claim 12, characterized in that the vessel lid is configured to be laterally displaceable with respect to the large vessel.

14. Vessel lid according to claim 12, characterized in that the sealing of the vessel lid with respect to the large vessel is improvable by vertical adjustment and/or tilting and/or lateral displacement of the vessel lid.

15. Vessel lid according to claim 12, characterized in that the vessel lid is configured to be arranged in the interior of the large vessel.

16. Vessel lid according to claim 12, characterized in that the vessel lid comprises exhaust ducts and connections for an exhaust.

17. Upwardly open large vessel, in particular a thermal plant, comprising a vessel lid according to claim 1 that is arranged in the interior of the large vessel.
